(19) United States
(12) Patent Application Publication
(10) Pub. No.: US 2011/0166485 A1
(43) Pub. Date: Jul. 7, 2011

(54) LEG-LIFTING DEVICE

(76) Inventor: Daniel Earl Owens, Rutherfordton, NC (US)

(21) Appl. No.: 12/652,416

(22) Filed: Jan. 5, 2010

(51) Int. Cl. A61H 1/02

(52) U.S. Cl. 601/5

(57) ABSTRACT

A leg-lifting device includes an at least semirigid arm, a handle connected to the arm at a first end thereof and positioned perpendicularly with respect to the arm, and a ring connected to the arm at a second end thereof and positioned opposite the handle for being positioned around an appendage and lifting the appendage under manual control of the person by use of the handle. A collar connects the ring to the arm at the second end of the arm opposite the handle. The collar is positioned perpendicularly with respect to the arm and adapted to maintain the ring open to better position the ring around an appendage.

### TECHNICAL FIELD OF THE INVENTION

This invention relates generally to a device for positioning an appendage, and more particularly to a device that facilitates manual lifting and positioning a leg having limited independent mobility.

### BACKGROUND OF THE INVENTION

Injuries, other incidents that adversely affect personal health, and even natural aging can limit the independent mobility of the legs. Hip replacements, knee replacements, strokes, and paralysis can all render the legs partially or entirely incapable of independently executing their full ranges of motion relative to a healthy mobile condition. Conditions of limited mobility may be short or long term, and their durations and severities often depend on the activities undergone through therapy and exercise.

While human assistance and therapeutic services are of course available, such help can be expensive and can limit independence and personal privacy. Many aging, injured, and rehabilitating people would prefer independence when attending to personal activities such as rising from a bed and visiting a restroom. Even where assistance may be freely available from young or healthy family members, many people suffering from limited mobility of one or both legs prefer to limit what they perceive as a burden on their families. Many couples aging naturally together have limited abilities to assist each other in such simple activities such as rising from a chair.

Thus needs are apparent, particularly as medical science and better education toward healthy diets help to extend our lifespans and improve survival rates from injuries and life-threatening conditions. Not all needs for improving independent mobility are met by powered chairs, walkers and other bulky, expensive, or maintenance-intensive technologies. This is particularly true in home environments, assisted living quarters, and even hospital rooms and restrooms where space is limited and furniture offerings are not entirely uniform or compatible with complex mobility-assisting contraptions.

### BRIEF SUMMARY OF THE INVENTION

Accordingly, there is a need for a leg-lifting device for use by a person to position a leg by manual control of the device using one or both hands. In at least one embodiment of the invention, a leg-lifting device includes an at least semirigid arm, a handle connected to the arm at a first end thereof and positioned perpendicularly with respect to the arm, and a ring connected to the arm at a second end thereof and positioned opposite the handle for being positioned around an appendage and for lifting the appendage under manual control of the person by use of the handle.

In at least one embodiment, the leg-lifting device includes a collar connected to the arm at the second end thereof. The collar is positioned opposite the handle and connects the ring to the arm.

In at least one embodiment, the collar is positioned perpendicularly with respect to the arm and is adapted to maintain the ring open to better position the ring around an appendage.

In at least one embodiment, the arm includes a tubular material.

In at least one embodiment, the arm includes a material selected from a group of materials consisting of plastic and metal.

In at least one embodiment, the ring is contained in a flexible tubing cover suitable for cleaning and disinfecting.

In at least one embodiment, the flexible tubing cover includes polyethylene tubing.

In at least one embodiment, the ring includes a length of synthetic rope.

In at least one embodiment of the invention, a leg-lifting device includes an at least semirigid arm, a handle connected to the arm at a first end thereof and positioned perpendicularly with respect to the arm, a collar connected to the arm at a second end thereof and positioned opposite the handle, and a ring connected to the collar and positioned opposite the handle for being placed around an appendage and lifting the appendage under manual control of the person by use of the handle.

In at least one embodiment, the handle includes a hollow tube positioned perpendicularly with respect to the arm, and two end caps connected to the two ends to the hollow tube opposite each other.

In at least one embodiment of the invention, leg-lifting device for use by a person to position a leg by manual control of the device using one or both hands includes encircling means for looping and capturing an appendage, extending means for positioning the encircling means around the appendage, and handling means for manually controlling the extending means and encircling means therewith and for lifting each to lift the captured appendage and selectively position the appendage.

In at least one embodiment, the leg-lifting device further includes collar means for joining the encircling means to the extending means and for maintaining the encircling means open to better loop and capture the appendage.

In at least one embodiment, the collar means is positioned perpendicularly with respect to the extending means.

In at least one embodiment, the encircling means and handling means are connected to the extending means at opposite ends thereof.

In at least one embodiment, the handling means is positioned perpendicularly with respect to the extending means.

### BRIEF DESCRIPTION OF THE DRAWINGS

The subject matter that is regarded as the invention may be best understood by reference to the following description taken in conjunction with the accompanying drawing figures in which:

FIG. 1 is a plan view of a leg-lifting device according to one embodiment of the invention;

FIG. 2 is a plan view of the leg-lifting device of FIG. 1 shown provided with a cover surrounding the ring according to another embodiment of the invention;

FIG. 3 is an environmental view of either embodiment of FIG. 2 or 3 shown in use.

### DETAILED DESCRIPTION OF THE INVENTION

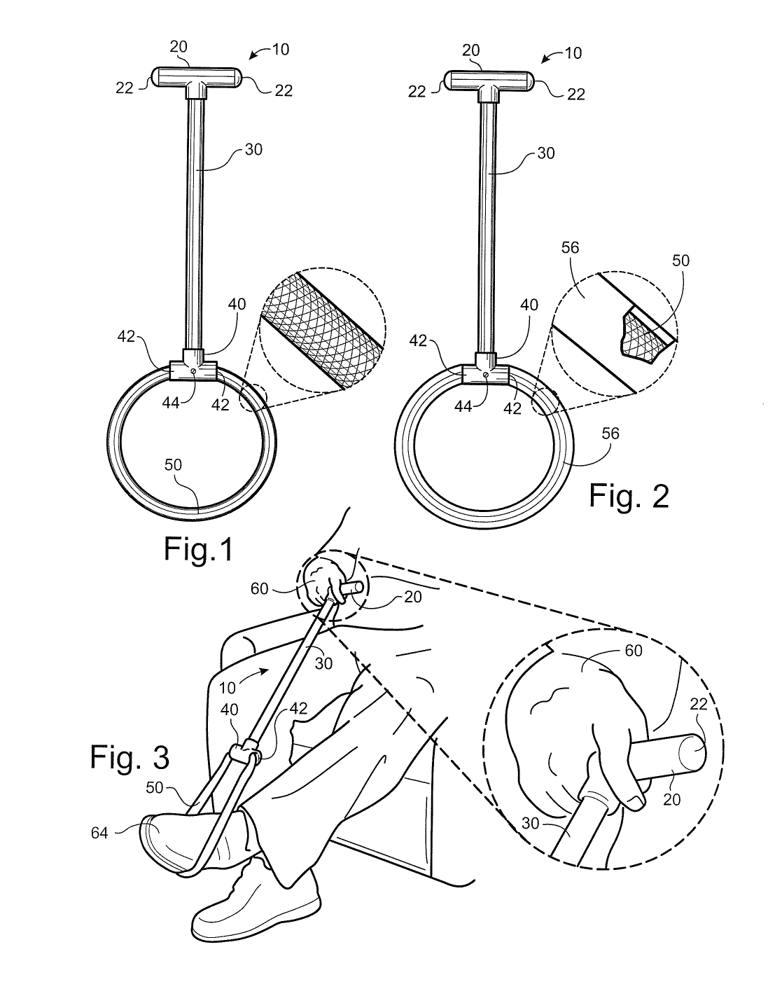

Referring to the drawings wherein identical reference numerals denote the same elements throughout the various views, FIG. 1 illustrates a leg-lifting device 10 according to at least one embodiment of the invention. The leg-lifting device 10 includes a handle 20, a rigid arm 30 extending longitudinally from the handle 20, a collar 40 connected to the arm 30 opposite the handle 20, and a ring 50 adapted for encircling a foot or leg end so that a leg can be lifted and positioned by manual use of the handle 20 and arm 30.

The arm 30 is rigid or at least semirigid for use in extending the ring 50 toward a foot or leg end, positioning the ring around the foot or leg end to encircle and capture the appendage, and manipulating the ring 50 and the captured appendage therewith. The handle 20 is connected to the arm 30 opposite the collar 40. Like the arm 30, the handle 20 is rigid or at least semirigid. In the illustrated embodiment, each of the arm 30 and the handle 20 is a tubular member having a circular cross section, but these descriptions relate to other constructions as well. For example, the arm 30 and/or the handle 20 may be solid or hollow, and may have a square-shaped or other-shaped cross section as well. The arm 30 is sufficiently long to extend between a comfortable hand position and a foot or leg end. For example, the arm 30 can be approximately the length of a calf of the leg of a user, thus assuring that a user who can comfortably reach his or her knee, can position the ring 50 about his or her foot or leg end without reaching a hand beyond a comfortable position.

Arms 30 having various lengths may be available for various users. Furthermore, in some embodiments, the arm 30 has adjustable length. In one example the arm 30 is constructed from multiple telescoping tubes, one of which can be extended from within another to increase the length of the arm 30. In that example the relative position of an inner tube relative to an outer tube can be fixed by a pin that extends from within the inner tube and through holes in each tube that reach alignment by relative movement of the tubes. The pin is biased outward by an internal spring within the inner tube such that the pin is pressed by the spring toward its locking position in which it extends through both tubes. The pin can be pressed by a finger inward to release the inner tube for telescopic adjustment relative to the outer tube. The pin preferably has a rounded or beveled button-like end to facilitate the release and to minimize snagging and sticking of the tubes relative to each other during adjustment. Alternatively, two telescoping pieces of the arm 30 may be fixed in any preferred relative position by turning a locking collar thereby squeezing a compressible or split bushing that bears upon either or both pieces to lock their current position.

The handle 20 is sufficiently wide to accommodate a human hand when grasped, and facilitates easy control of the leg-lifting device 10 by a single hand. The handle may come in more than one size to serve adults, children, and people having various hand sizes. The handle 20 is illustrated as T-shaped and symmetric with respect to the arm 30. The T-shaped handle permits use of one or two hands to control the leg-lifting device according to the preference of the user. Other embodiments of the handle 20 facilitating both single and two-handed operation are nonetheless within the scope of these descriptions. A typical grasping position for a hand 60 is shown in the enlarged portion of FIG. 3. The ends 22 of the handle 20 are beveled or rounded in the illustrated embodiment in order to provide for hand comfort and to minimize any chance of injury or scratching one's hands or other body parts.

The collar 40 connected to the arm 30 opposite the handle 20 is also rigid or at least semirigid. The collar 40 may be entirely hollow or partially solid. The collar 40 has opposing sockets 42 that are at least hollow to a sufficient extent for each to receive a portion of the ring 50. In at least one embodiment, two ends of the ring 50 are attached together within the collar 40 by a crimped connector. In another embodiment, two ends of the ring 50 are attached together by a secure knot within the collar 40. In yet another embodiment, the ring 50 has a continuous construction having no well defined ends but having a portion positioned within the collar 40. In the illustrated embodiment, a fixing element 44, illustrated for purposes of example as a screw, fixes the ring 50 relative to the collar 40 to prevent rotation of the ring 50 through the collar 40. The collar 40 is sufficiently wide between the opposing sockets 42 to spread the ring 50 as it extends from the collar 40 to assure the ring 50 is sufficiently open to be passed around a foot or leg end.

The ring 50 is thick and non-collapsing in order to assure it remains open as it extends from the collar 40. This is advantageous at the time of positioning the ring 50 around a foot or leg and at the time of removing the ring 50 from around the appendage. The ring 50 is somewhat flexible and shape conforming to comfortably cradle an encircled foot or leg end. The ring 50 is formable and maintains its assigned shape under its own weight so that a user can form it to a preferred shape in preparation for positioning around a foot or leg end. The ring 50 has a sufficiently wide cross-sectional diameter to prevent stressing delicate skin as the ring encircles and carries a foot or leg. The generous cross-sectional diameter of the ring serves to prevent collapse so that the ring remains open and to prevent irritating or stressing any skin directly contacted or bearing any lifting forces through clothing such as socks.

In FIG. 2, a cover 56 is shown surrounding the ring 50. The cover 56 protects the ring 50 from directly contacting a user's feet, socks, or shoes and other environmental elements that may soil the ring 50. This may be particularly beneficial in a hospital or assisted living facility where the leg-lifting device 10 may be used by more than one person. The cover 56 also serves to protect the ring 50 from snags and other wear problems. The cover 56 is preferably constructed of a non-porous material that is more than semirigid but less than entirely rigid, but is at least somewhat yielding and shape conforming to comfortably cradle an encircled foot or leg end. The cover 56 is preferably constructed from a material that is able to withstand washing, that conveniently dries in room conditions, and that withstands exposure to sanitizing solutions. For example, the cover 56 may be constructed of clear polyethylene tubing, although other materials by which the cover 56 may be constructed are within the scope of these descriptions.

As shown in FIG. 3, the leg-lifting device 10 is used by grasping the handle 20, with the arm 30 being controlled through the handle 20 and extended toward the foot 64 or leg end desired to be moved. The ring 50 is then guided by movement of the handle 20 to encircle the foot 64, and the foot and leg therewith is then moved under the control of the handle 20. The leg-lifting device 10 is useful to move a leg and to exercise or stretch the leg. For example, the leg-lifting device 10 is useful to stretch one's calf muscles and ligaments and to perform other therapeutic activities.

TABLE 1

| | | |
|---|---|---|
| Overall longitudinal length from handle 20 to | 18 | inches |
| collar 40: | | |
| Transverse length of handle 20: | 4⅝ | inches |
| Cross-sectional diameter of handle: | 1 | inch |
| Cross-sectional diameter of arm 30: | 13/16 | inches |
| Transverse length of collar 40: | 2⅜ | inches |
| Cross-sectional diameter of collar 40: | 1 | inch |
| Circumference of ring 50: | 24 | inches |
| Cross-sectional diameter of ring 50: | 9/16 | inch |

| | |
|---|---|
| Ring 50 pulled tight along handle 20 reaches | 10 inches or 5/9 |
| approximately: | of overall |
| | longitudinal |
| | length from collar |
| | 40 to handle 20 |

Although other dimensions are within the scope of these descriptions, several measurements are provided in Table 1 for the purpose of detailing a non-limiting example. These measurements provide an example only without limiting these overall descriptions to any particular absolute or relative terms. But it can be said that in at least one embodiment of the leg-lifting device 10, the measurements provided in Table 1 apply.

Although other materials are within the scope of these descriptions, in the illustrated embodiment the arm 30, handle 20, and collar 40 are constructed of polyvinyl chloride (PVC) plastic. In particular, the arm 30 is constructed of PVC tubing and the collar 40 is a PVC T-joint. The handle 20 is assembled as a T-joint connected to the arm 30, internal pieces of PVC tubing (not shown) connected to the T-joint at its opposing ends, and end caps connected to the internal pieces to define the opposing ends 22 of the handle 20. The internal and external diameters of these components correspond to available PVC components known nominally as ½ inch components. Thus, the leg-lifting device 10 illustrated in the figures is described here as constructed of PVC tubing, T-joints, and caps for the purpose of detailing a non-limiting example. This example is provided here as an example only without limiting these overall descriptions.

Other materials and assemblies for constructing the leg-lifting device 10 are nonetheless within the scope of these descriptions. For example, the leg-lifting device 10 could otherwise be formed by injection molding a material such as plastic. The leg-lifting device 10 could be formed as several assembled components of the same material as exemplified in the preceding descriptions, or the leg-lifting device 10 could be formed as a single integrally formed piece of material. The leg-lifting device 10 or each component thereof could be constructed from round or other-shaped metal stock such as aluminum or light weight composite material such as resin filled woven carbon fibers. The leg-lifting device 10 and each component thereof may be formed of hollow tubular material such as metal or plastic tubing, and may otherwise be solid throughout. None of these examples impose limitations on these descriptions.

The ring 50 may be formed from braided nylon rope or may be formed from another suitable material. Other non-limiting examples by which the ring 50 may be formed include both natural and synthetic fibers, both monofilament and polyfilament lines, hemp or cotton rope or strap material, leather, plastic tubing, and elastic surgical tubing. The ring 50 may have a circular cross-section or may have another cross-sectional shape.

While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A leg-lifting device for use by a person to position a leg by manual control of the device using one or both hands, comprising:
(a) an at least semirigid arm;
(b) a handle connected to the arm at a first end thereof and positioned perpendicularly with respect to the arm; and
(c) a ring connected to the arm at a second end thereof and positioned opposite the handle for being positioned around a leg and lifting the leg under manual control of the person by use of the handle.

2. A leg-lifting device according to claim 1, further comprising a collar connected to the arm at the second end thereof, positioned opposite the handle, and connecting the ring to the arm.

3. A leg-lifting device according to claim 2, wherein the collar is positioned perpendicularly with respect to the arm and adapted to maintain the ring open to better position the ring around an appendage.

4. A leg-lifting device according to claim 1, wherein the arm comprises a tubular material.

5. A leg-lifting device according to claim 1, wherein the arm comprises a material selected from a group of materials consisting of plastic and metal.

6. A leg-lifting device according to claim 1, wherein the ring is contained in a flexible tubing cover suitable for cleaning and disinfecting.

7. A leg-lifting device according to claim 6, wherein the flexible tubing cover comprises polyethylene tubing.

8. A leg-lifting device according to claim 1, wherein the ring comprises a length of synthetic rope.

9. A leg-lifting device for use by a person to position a leg by manual control of the device using one or both hands comprising:
(a) an at least semirigid arm;
(b) a handle connected to the arm at a first end thereof and positioned perpendicularly with respect to the arm;
(c) a collar connected to the arm at a second end thereof and positioned opposite the handle; and
(d) a ring connected to the collar and positioned opposite the handle for being placed around an appendage and lifting the appendage under manual control of the person by use of the handle.

10. A leg-lifting device according to claim 9, wherein the handle comprises a hollow tube positioned perpendicularly with respect to the arm, and two end caps connected to the two ends to the hollow tube opposite each other.

11. A leg-lifting device according to claim 9, wherein the arm comprises a tubular material.

12. A leg-lifting device according to claim 11, wherein the tubular material is selected from a group of materials consisting of plastic and metal.

13. A leg-lifting device according to claim 9, wherein the ring is contained in a flexible tubing cover suitable for cleaning and disinfecting.

14. A leg-lifting device according to claim 9, wherein the handle is T-shaped and is symmetric with respect to the arm.

15. A leg-lifting device according to claim 9, wherein the collar is T-shaped and symmetric with respect to the arm.

16. A leg-lifting device for use by a person to position a leg by manual control of the device using one or both hands comprising:
(a) encircling means for looping and capturing an appendage;
(b) extending means for positioning the encircling means around the appendage; and
(c) handling means for manually controlling the extending means and encircling means therewith and for lifting each to lift the captured appendage and selectively position the appendage.

17. A leg-lifting device according to claim 16, further comprising collar means for joining the encircling means to the extending means and for maintaining the encircling means open to better loop and capture the appendage.

18. A leg-lifting device according to claim 17, wherein the collar means is positioned perpendicularly with respect to the extending means.

19. A leg-lifting device according to claim 16, wherein the encircling means and handling means are connected to the extending means at opposite ends thereof.

20. A leg-lifting device according to claim 16, wherein the handling means is positioned perpendicularly with respect to the extending means.
